(19) United States
(12) Patent Application Publication
(10) Pub. No.: US 2015/0301582 A1
(43) Pub. Date: Oct. 22, 2015

(54) Energy Efficient Mobile Device

(71) Applicant: Yang Pan, Singapore (SG)

(72) Inventor: Yang Pan, Singapore (SG)

(21) Appl. No.: 14/257,005

(22) Filed: Apr. 21, 2014

(51) Int. Cl. G06F 1/32; G06F 9/50

(52) U.S. Cl. CPC G06F 1/3234; G06F 1/3203; G06F 9/5094

(57) ABSTRACT

In one embodiment, an energy efficient mobile computing and communication device selects its operation mode based upon analyzing of a user's habit of selecting application programs. Each of the operation modes is associated with a set of applications. Power consumptions of each of the operation modes can be ranked sequentially. In another embodiment, an energy efficient mobile device selects one of the cores of its processor based upon analyzing of the user's habit of selecting the application programs. Each of the cores is associated with a set of applications. Power consumptions of each of the cores can be ranked sequentially.

### CROSS-REFERENCE TO RELATED APPLICATIONS

Not applicable.

### BACKGROUND

1. Field of Invention

This invention relates to a mobile computing and communication device, specifically to an energy efficient mobile computing and communication device.

2. Description of Prior Art

A mobile device such as, for example, a smart phone or a tablet computer is powered by a battery. It is always desirable to increase operating time and to reduce frequency of recharging the battery. Today, a mobile device may include many application programs provided by a device manufacturer or by an independent application developer. One user may use only a portion of the applications. Another user may use all of the applications or even purchase additional applications from an on-line shop. It is therefore desirable that the mobile device consumes power in an intelligent manner by taking consideration of a user's habit of using the applications to increase the battery operating time as much as possible.

### SUMMARY OF THE INVENTION

It is an object of the present invention for providing an energy efficient mobile device.

It is another object of the present invention for providing an energy efficient mobile device that employs a processor with multiple operating modes, wherein each of the operating modes is associated with a set of application programs, wherein each of the operating modes is characterized by different power consumption.

It is yet another object of the present invention for providing an energy efficient mobile device that employs a processor with multiple cores, wherein each of the cores is associated with a set of application programs, wherein each of the cores is characterized by different power consumption.

It is still another object of the present invention for providing an energy efficient mobile device that collects and analyzes a user's habit of using the applications and selects an operation mode of a multi-mode processor or a core of a multi-core processor in accordance with a result of analyzing.

### BRIEF DESCRIPTION OF THE DRAWINGS

For a more complete understanding of the present invention and its various embodiments, and the advantages thereof, reference is now made to the following description taken in conjunction with the accompanying drawings:

FIG. 1 is a schematic diagram of an exemplary energy efficient mobile device in accordance of the first embodiment;

FIGS. 2A-B is a flow diagram depicting power saving operation of the mobile device in accordance with the first embodiment;

FIG. 3 is a schematic diagram of an exemplary energy efficient mobile device in accordance of the second embodiment;

FIGS. 4A-B is a flow diagram depicting power saving operation of the mobile device in accordance with the second embodiment.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

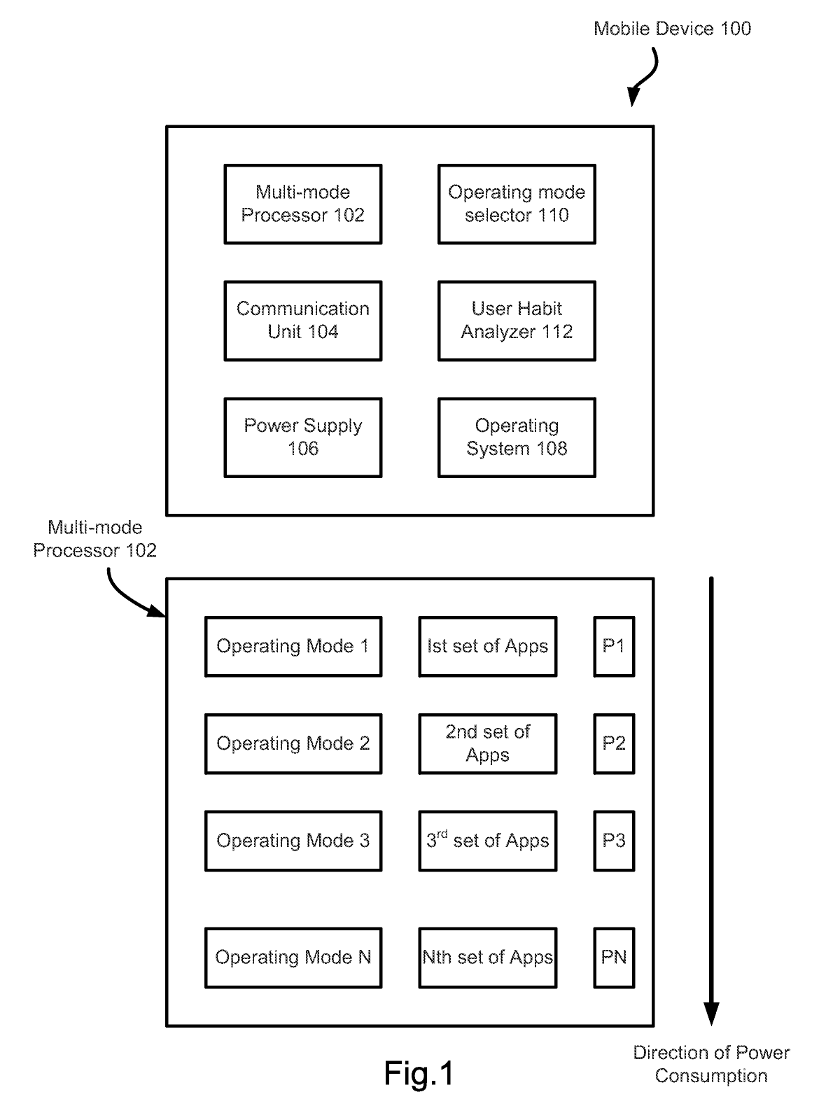

FIG. 1 is a schematic diagram of an exemplary energy efficient mobile device 100 (top figure) in accordance with the first embodiment. The mobile device 100 includes a processor 102, a communication unit 104 and a power supply 106. The mobile device 100 further includes an operating system 108. The mobile device 100 is connected to one or more communication network through communication 104. The communication network includes but is not limited to the Internet. Power supply 106 is a rechargeable battery in one implementation. According to the first embodiment of the present invention, the processor 102 includes multiple operating modes and is called multi-mode processor.

The mobile device 100 provides a plurality of application programs or Apps. A user can select an App through a user interface of the mobile device displayed on a screen of the mobile device. In one implementation, the screen is a touch-sensitive screen and Apps are displayed user selectable icons.

In the first embodiment, the multi-mode processor 102 as shown in the bottom figure includes a plurality of operating modes. Each of the operating modes can support a set of Apps. Each of operating modes consumes substantially different power. The direction of power consumption is illustrated in the bottom figure. Each of the operating modes may consume substantially different power.

The user's history of selecting of Apps is recorded by the multi-mode processor 102 and is stored as a data file in a storage unit (not shown in the figure) of mobile device 100. The data file is analyzed by user habit analyzer 112 which is a software program stored in mobile device 100. The analyzer 112 may count and rank Apps that the user selected over a period of time such as, for example, over a month. The analyzer 112 may track a trend of anyone of the Apps selected by the user over a plurality of equally divided time periods. As shown in the bottom figure, operating mode 2 consumes more power (P2) than operating mode 1 (P1). The second set of Apps may include all Apps belonging to the first set of Apps and include one or more different Apps. The different Apps may be additions to the first set of Apps. The third set of Apps may include all Apps belonging to the second set of Apps and include one or more different Apps. The Nth set of Apps may include all Apps supported by the mobile device 100.

Operating mode selector 110 selects an operating mode based upon a result provided by user habit analyzer 112. The multi-mode processor 112 is subsequently operated according to selected operating mode.

The selected operating mode may support a significant high percentage of Apps used by the user previously either based upon ranking or upon a usage trend. In an exemplary implementation without limiting scope of the present invention, the selected operating mode may support Apps used by the user in a range of 85 to 95%.

If an App is selected by the user that is not supported by the present operating mode, the operating mode selector 110 will select another operating mode. Multi-mode processor 102 will subsequently run the newly selected operating mode to support the newly selected App.

Operating system 108 may be tailored or customized to run each of the operating modes. For an operating mode supports less Apps, a tailored or customized operating system consumes less power.

Some of functional blocks of the mobile device 100 may be switched off if the selected operating mode does not support Apps that requires the functional blocks to be active. The function blocks includes but is not limited to communication unit 104.

In one implementation, categorization of Apps and association of the Apps with the operating modes is carried out by a manufacturer of the mobile device before the device is shipped to the user. The categorization may be based upon data collected from a large number of users. The data may include but is not limited to age, sex, nationality and educational background.

In another implementation, categorization of Apps and association of the Apps with the operating modes is carried out at least partly by a user of the mobile device in the field. The operating system 108 will need to provide flexibility for such a field customization of the operating system and the processor.

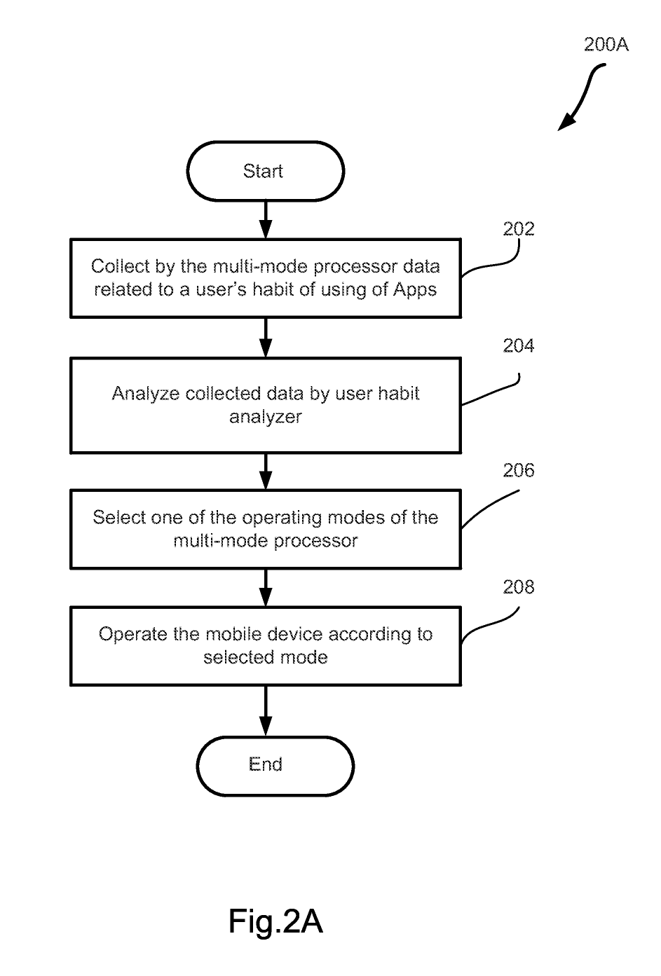

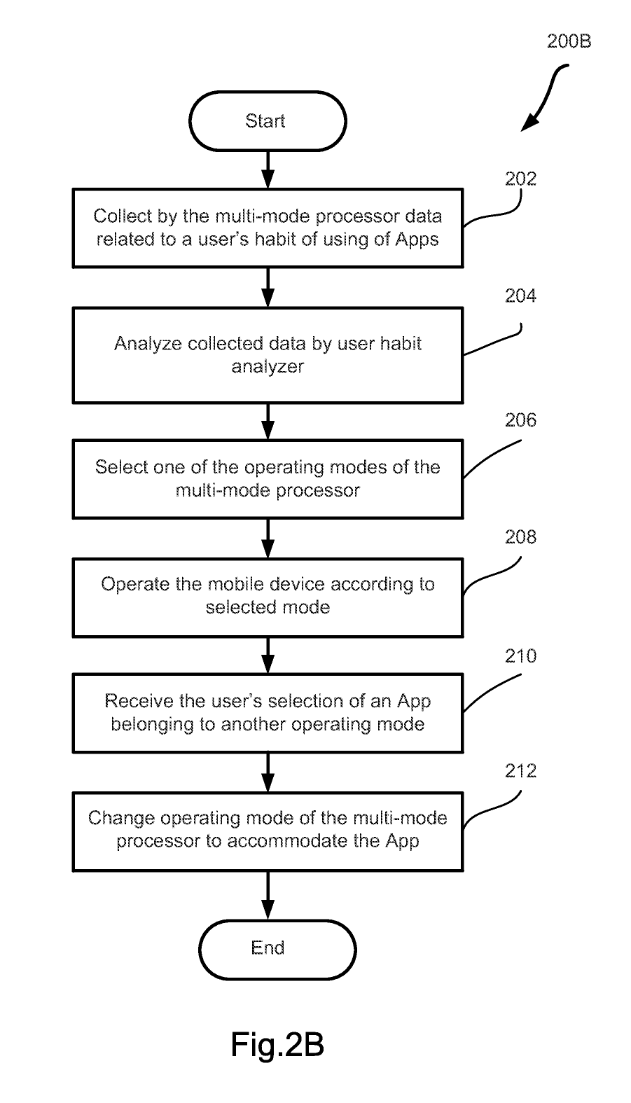

FIG. 2A is a flow diagram depicting power saving operation of the mobile device in accordance with the first embodiment. Process 200A starts with step 202 that a user's habit of using of Apps is collected by multi-mode processor 102. The collected data may be stored in a data file stored in the storage unit of the mobile device 100. The collected user's habit or history of using the Apps is analyzed by user habit analyzer 112 in step 204. The multi-mode processor 102 selects one of the operating modes through the operating mode selector 110 in step 206. Upon the selection, the mobile device 100 is operated according to selected operating mode in step 208.

Sometimes, a new App not belonging to the operating mode being run may be selected by the user as shown in step 210 of FIG. 2B. In such a circumstance, the processor 102 will need to change to a new operating mode to accommodate the newly selected App as shown in step 212.

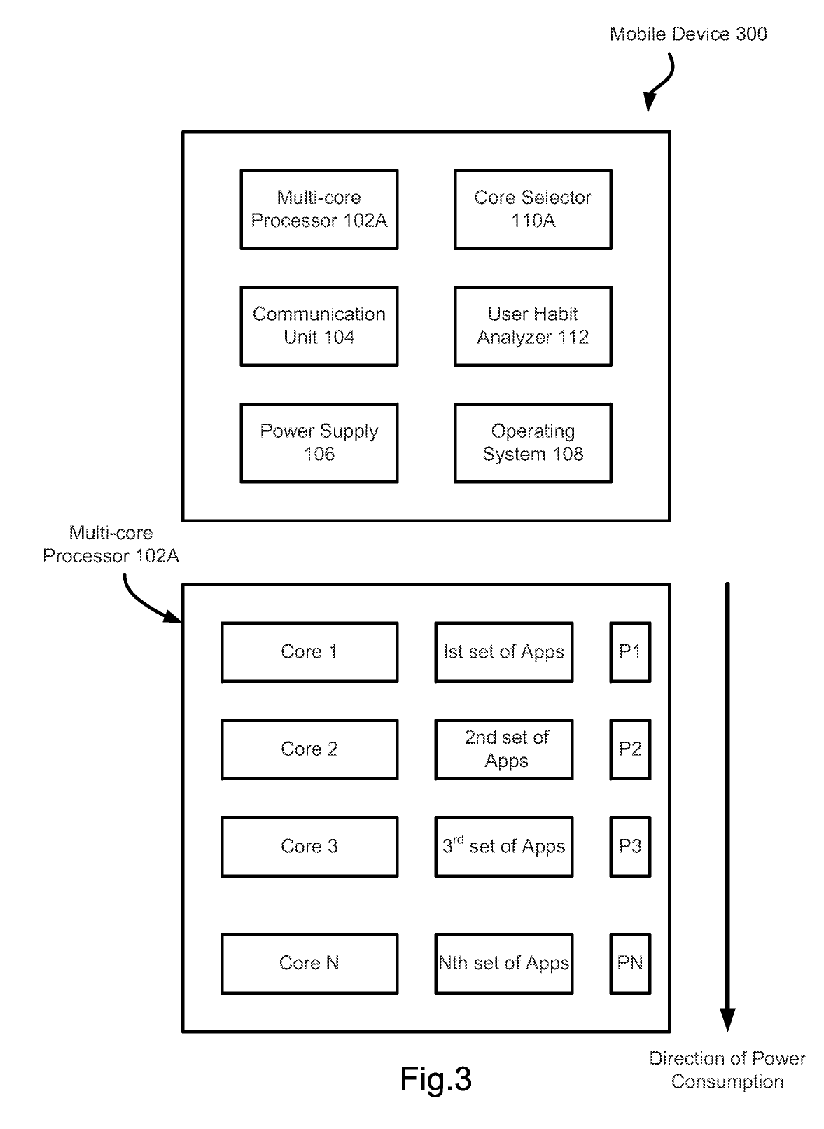

FIG. 3 is a schematic diagram of an exemplary mobile device 300 in accordance of the second embodiment. The mobile device 300 includes a processor 102A, a communication unit 104 and a power supply 106. The mobile device 300 further includes an operating system 108. The mobile device 300 is connected to one or more communication network through communication 104. The communication network includes but is not limited to the Internet. Power supply 106 is a rechargeable battery in one implementation. According to the second embodiment of the present invention, processor 102 includes multiple cores or processors and is called multi-core processor.

The mobile device 100 provides a plurality of application programs or Apps. A user can select an App through a user interface of the mobile device displayed on a screen of the mobile device. In one implementation, the screen is a touch-sensitive screen and Apps are displayed user selectable icons.

In the second embodiment, the multi-core processor 102A as shown in the bottom figure includes a plurality of cores. Each of the cores can support a set of Apps. Each of cores consumes substantially different powers. The direction of power consumption is illustrated in the bottom figure.

The user's history of selecting of Apps is recorded by the multi-core processor 102A and is stored as a data file in a storage unit (not shown in the figure) of mobile device 300. The data file is analyzed by user habit analyzer 112 which is a software program stored in mobile device 300. The analyzer 112 may count and rank Apps that the user selected over a period of time such as, for example, over a month. The analyzer 112 may track a trend of anyone of the Apps selected by the user over a plurality of equally divided time periods. As shown in the bottom figure, core 2 consumes more power (P2) than core 1 (P1). The second set of Apps may include all Apps belonging to the first set of Apps and include one or more different Apps. The one or more different Apps may be additions to the first set of Apps. The third set of Apps may include all Apps belonging to the second set of Apps and include one or more different Apps. The Nth set of Apps may include all Apps supported by the mobile device 300.

Core selector 110A selects a core based upon a result provided by user habit analyzer 112. The multi-core processor 112A is operated employing the selected core. Other cores are switched off to save power consumption.

The selected core may support a significantly high percentage of Apps used by the user previously either based upon ranking or upon a usage trend. In an exemplary implementation without limiting scope of the present invention, the selected core may support Apps used by the user in a range of 85 to 95%.

If an App is selected by the user that is not supported by the present core, the core selector 110A will select another core. Multi-core processor 102A will subsequently run the newly selected core to support the newly selected App.

Operating system 108 may be tailored or customized to be run at each of the cores. For a core supports less Apps, a tailored or customized operating system consumes less power.

Some of functional blocks of the mobile device 300 may be switched off if the selected core does not support Apps that requires the functional blocks to be active. The function blocks includes but is not limited to communication unit 104.

In one implementation, categorization of Apps and association of the Apps with the cores is carried out by a manufacturer of the mobile device or an independent application developer before the device is shipped to the user. The categorization may be based upon data collected from a large number of users. The data may include age, sex, nationality and educational background.

In another implementation, categorization of Apps and association of the Apps with the cores is carried out at least partly by a user of the mobile device in the field. The operating system 108 will need to provide flexibility for such a field customization of the operating system and the processor.

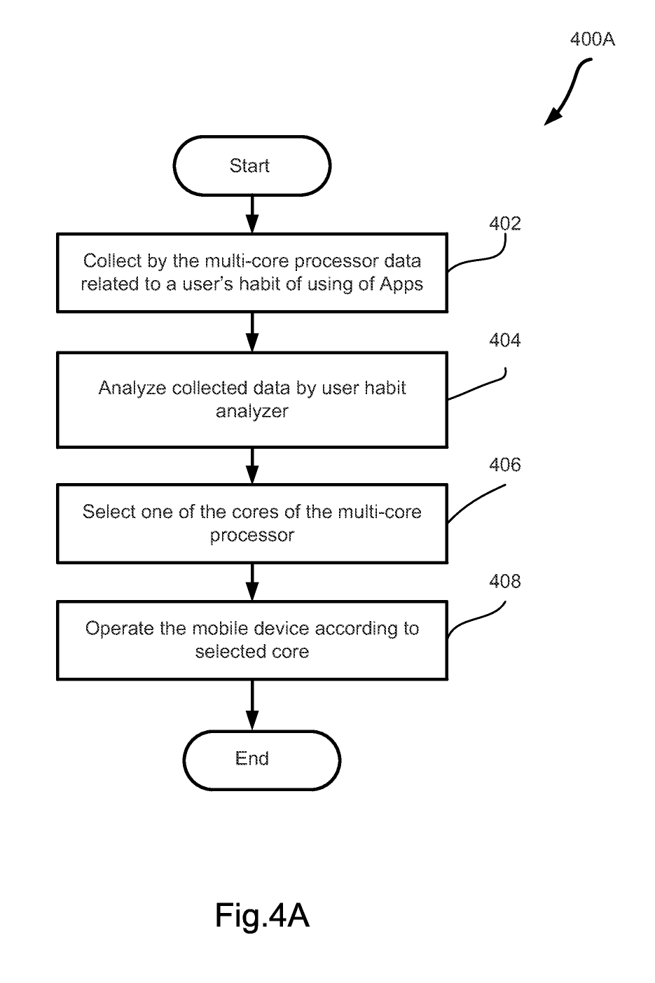

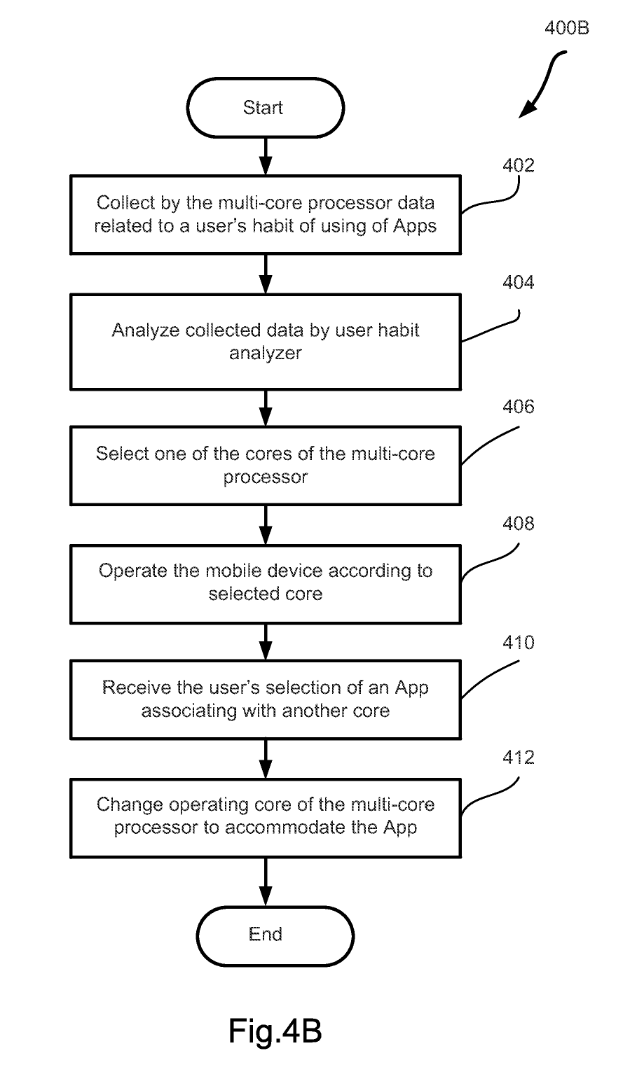

FIG. 4A is a flow diagram depicting power saving operation of the mobile device 300 in accordance with the second embodiment. Process 400A starts with step 402 that a user's habit of using of Apps is collected by multi-core processor 102A. The collected data may be stored in a data file stored in the storage unit of the mobile device 300. The collected user's habit or history of using the Apps is analyzed by user habit analyzer 112 in step 404. The multi-core processor 102A selects one of the cores through the core selector 110A in step 406. Upon the selection, the mobile device 300 is operated according to selected core in step 408.

Sometimes, a new App not belonging to the presently running core may be selected by the user as shown in step 410 of FIG. 4B. In such a circumstance, the processor 102A will need to change to a new core to accommodate the newly selected App as shown in step 412.

1. A mobile computing and communication device comprising:
(a) a processor comprising a plurality of operating modes, wherein each of the operating modes is associated with a set of applications and is associated with a power consumption;
(b) a user habit analyzer pertaining to collecting and analyzing the user's habit of using of the applications and to generating a result of analyzing; and
(c) an operating mode selector pertaining to selecting one of the operating modes according to generated result.

2. The device as recited in claim 1, wherein said power consumptions associated with each of the operating modes can be ranked sequentially.

3. The devices as recited in claim 2, wherein an operation mode associated with higher power consumption has at least one different application than an operation mode associated with lower power consumption.

4. The device as recited in claim 1, wherein an operating mode selected by said operating mode selector can be changed by said operating mode selector if an application request from the user is received by said processor, wherein requested application is not included in the operating mode being run.

5. The device as recited in claim 1, wherein said processor categorizing of operating modes associated with the applications before said device is shipped to the user.

6. The device as recited in claim 5, wherein said processor categorizing of applications based upon application usage data collected from a plurality of users.

7. The device as recited in claim 1, wherein said processor categorizing of operating modes associated with applications based upon at least partly inputs from the user through a user interface of said device.

8. The device as recited in claim 1, wherein said device is a mobile phone.

9. The device as recited in claim 1, wherein said device is a tablet computer.

10. The device as recited in claim 1, wherein said device is a laptop computer.

11. A mobile computing and communication device comprising:
(a) a processor comprising a plurality of cores, wherein each of the cores is associated with a set of applications and is associated with a power consumption;
(b) a user habit analyzer pertaining to collecting and analyzing the user's habit of using of the applications and to generating a result of analyzing; and
(c) a core selector pertaining to selecting one of the cores according to generated result.

12. The device as recited in claim 11, wherein said power consumptions of said cores can be ranked sequentially.

13. The devices as recited in claim 12, wherein a core associated with higher power consumption has at least one different application than a core with lower power consumption.

14. The device as recited in claim 11, wherein said device is operated base upon selected core, wherein another core is selected if an application request from the user is received by said processor, wherein requested application is not included in the core being used.

15. The device as recited in claim 11, wherein association of cores and applications is carried out before said device is shipped to the user.

16. The device as recited in claim 15, wherein said association is based upon application usage data collected from a plurality of users.

17. The device as recited in claim 11, wherein association of said cores with applications is done based upon at least partly inputs from the user through a user interface of said device.

18. A power management method of a mobile computing and communication device comprising:
(a) collecting a user's usage of a plurality of applications of the mobile device over a predetermined period of time;
(b) analyzing collected data by a multi-mode or a multi-core processor;
(c) selecting an operation mode or a core based upon a result of said analyzing, wherein each of the operation modes or each of cores is associated with a set of predetermined applications and with substantially different power consumptions; and
(d) operating the mobile device based upon selected operation mode or selected core.

19. The method as recited in claim 18, wherein said method further including changing the selected operation mode or the core based upon the user's selection of a new application through a user interface of the mobile device.

20. The method as recited in claim 18, wherein said method further including setting up a default operation mode or a default core based on analyzing the collected data.
